(19) United States
(12) Patent Application Publication
(10) Pub. No.: US 2004/0028364 A1
(43) Pub. Date: Feb. 12, 2004

(54) Single mode optical fiber for WDM transmission, and manufacturing method of preform for the optical fibers

(76) Inventors: Hideya Moridaira, Ichihara (JP); Mitsuhiro Kawasaki, Ichihara (JP); Tamotsu Kamiya, Ichihara (JP)

Correspondence Address: ERIC ROBINSON, PMB 955, 21010 SOUTHBANK ST., POTOMAC FALLS, VA, 20165, US

(21) Appl. No.: 10/357,492

(22) Filed: Feb. 4, 2003

(30) Foreign Application Priority Data
Feb. 4, 2002 (JP) 2002-027345

(51) Int. Cl. G02B 6/22; C03B 37/018

(52) U.S. Cl. 385/127; 65/422; 65/416

(57) ABSTRACT

The optical fiber which enables the optical fiber transmission stabilized in the wavelength range of the pump light also, which is not used conventionally, and suppresses the non-linear effect on the occasion of WDM transmission is offered. The optical fiber for WDM transmission has at least three or more layers wherein the first core doped with germanium is located at the center and surrounded by the second core having a refractive index lower than the first core, and cladding having a refractive index lower than the first core and higher than second core surrounds the second or last core layer. The single mode optical fiber for WDM transmission has the following characteristics: cut off wavelength of 1400 nm or less, chromatic dispersion of 5-13 ps/nm/km at 1500 nm, zero dispersion wavelength of 1400 nm or less and transmission loss of 0-5 dB/km or less in the wavelength range from cut off wavelength to 1600 nm

### FIELD OF THE INVENTION

The present invention relates to a single mode optical fiber suitable for Wavelength Division Multiplexing (WDW) using distributed Raman amplification, and manufacturing method of the preform for the optical fiber.

### BACKGROUND OF THE INVENTION

In the WDM transmission system being developed in recent years, an erbium doped fiber amplifier (EDFA), which is equipped with erbium doped fiber, performs amplification of the optical signal. This optical amplifier can amplify the optical signal of wide range of the 1.55 μm wavelength band from 1520 nm to 1600 nm.

Generally the single mode optical fiber for WDM transmission is required to have low transmission loss. Furthermore, in order to prevent noise generation due to four-wave mixing (FWM) which is one of the non-linear effects, the single mode optical fiber should not have a zero dispersion wavelength in the operating wavelength band.

A first example of the optical fiber meeting such requirements is the conventional single mode optical fiber (SMF) having a zero dispersion wavelength in the 1.3 μm band. Since this fiber has high chromatic dispersion in the 1.55 μm band, it is used for the WDM transmission usually by being combined with a dispersion compensating device.

A second example is the non-zero dispersion-shifted fiber (NZ-DSF). The conventional dispersion-shifted fiber (DSF) has a zero dispersion wavelength in the 1.55 μm band, and is not suitable for WDM transmission. By adjusting its profile and shifting the zero dispersion wavelengths slightly to longer or shorter from the 1.55 μl m band, the NZ-DSF such as “True Wave(trademark)” etc, can be obtained.

The chromatic dispersion of this NZ-DSF is not zero but small, of few ps/nm/km, and hence it is usually used for the WDM transmission without or with a small amount of dispersion compensation.

However, since this NZ-DSF has high doping concentration of germanium and small mode field diameter (MFD), a nonlinear effect is strongly generated. Therefore, even if the FWM can be suppressed, disorders of the signal waveform due to the self-phase modulation (SPM), the cross phase modulation (XPM), etc. are generated. These disorders are proportional to the optical power density in the core of the optical fiber.

Although longer distance transmission with a large number of wavelengths requires a higher optical power input, the optical power density can be reduced by enlarging an effective area (Aeff) and the generation of the non-linear effect can be suppressed. An example of the optical fiber having low dispersion and Aeff of 70 μm² or more is known as “LEAF(trademark)”.

Recently, under the demand of expanding the wavelength band and increasing the amount of information per wave, a transmission system by using the distributed Raman amplifier is being studied, in addition to the above-mentioned EDFA.

In the transmission by the distributed Raman amplifier, a wide wavelength band can be more freely chosen as compared with an PDFA system and since an amiplification is performed along the longitudinal direction of a fiber, the optical signal has uniform power through the fiber and hence a noise low.

The Raman amplification can amplify the signal light having the wavelength of about 100 nm longer than the pump light. Therefore, the wavelength of the pump light should be in the range of 1400 to 1500 nm for Raman amplification of the signal light of 1500 to 1600 nm wavelength for VWDM transmission.

The above mentioned “SMF” having step-index profile and “LEAF” have a disadvantage of low amplification efficiency due to the low non-linear effect for Raman amplification. Although an optical fiber provided with low positive dispersion around 1.55 μm and high non-linear effect has high amplification efficiency, the noise from the pump light may occur because its zero dispersion wavelength lies in the wavelength range of the pump light.

Furthermore, to transmit the pump light over a long distance, it is also required that the transmission loss in this wavelength band should be low. But, the above mentioned conventional optical fibers do not satisfy this requirement, because they sometimes contain impurities such as hydroxyl ions.

Optical fibers with hydroxyl ions have especially high transmission loss around 1400 nm wavelength due to their absorption peak at 1380 nm. An optical fiber having the refractive index profile similar to SMF with reduced absorption peak, such as “Allwave (trademark)” etc, is proposed.

This fiber is applicable to WDM transmission in the wavelength range of 1300 nm to 1600 nm, but has the disadvantage of low Raman amplification efficiency due to low nonlinear effect. Also, the SMF and “Allwave(trademark)” fiber cannot sufficiently compensate the disorder of the waveform in a high speed transmission in the 1.55 μm band due to a high dispersion, even though compensated by using the dispersion compensating fiber.

As mentioned above, in the WDM transmission, an optical fiber which can satisfy both the suppression of the non-Linear effect and the stable transmission in the pump light wavelength band which has not conventionally been used is not proposed so far.

### SUMMARY OF THE INVENTION

This invention aims at offering the optical fiber adaptable for distributed Raman amplification and capable of increasing the amount of information per signal light wave in WDM transmission in a 1500-1600 nm wavelength band Namely, the present invention provides the fiber which suppresses the nonlinear effect and enables a stable transmission in the wavelength band of the pump light that has not been used conventionally, for WDM transmission.

After extensive experimentation, the inventors found that by setting the cutoff wavelength and zero dispersion wavelength smaller than 1400 nm and by making the transmission loss from cutoff wavelength to 1600 nm smaller than 0.5 dB/km, the non-linear effect is suppressed and also stable transmission even in the wavelength band of the pump light that has not been used conventionally are attained in WDM transmission.

According to the present invention, there is provided a single mode optical fiber for WDM transmission comprising a first core in the center which is doped with at least Germanium, a second core surrounding the first core, the refractive index of which is lower than the first core, and a cladding surrounding the second core, the refractive index of which is higher than the second core and lower than the first core, wherein a cutoff wavelength is 1400 nm or less, a dispersion is 5 to 13 ps/nm/km at 1500 nm, a zero dispersion wavelength is 1400 nm or less, and a transmission loss is 0.5 dB/km or less in the wavelength from the cutoff wavelength to 1600 nm.

In one embodiment of the single mode optical fiber according to the present invention further comprises a third core, having higher refractive index than the cladding, between the second core and the cladding.

In another embodiment, the single mode optical fiber according to the present invention further comprises a fourth core, having lower refractive index than the cladding, between the third core and the cladding.

According to the present invention, there is provided a method for producing a preform of a single mode optical fiber for WDM transmission comprising the following steps: forming a porous soot preform of silica by flame hydrolysis process with adjusting a doping concentration of Germanium according to a required refractive index profiles, dehydrating the porous soot preform in an atmosphere a chlorine or chlorine composite at a temperature of 1250° C. or less, and sintering the dehydrated porous soot preform in an atmosphere containing fluorine to make a transparent glass rod.

In the method, a porous soot member is further formed on the glass rod, dehydrated and sintered in the above atmospheres to make an additional transparent glass member which corresponds to a third and/or a forth cores or cladding. A porous soot member is formed on a second glass rod comprising the transparent glass rod and the transparent glass member to make a cladding where the transparent glass member corresponds to the third and/or for the cores.

Before the formation of the porous soot member, a hydrous layer in the transparent glass rod or the transparent glass body is removed by etching or polishing the surface thereof. As a step of forming a cladding, the transparent glass rod or a second glass rod is extended through a heating process and a hydrous layer is removed from the surface of the extended glass rod or second glass rod. A silica tube having a concentration of hydroxyl ions less than 100 ppm by weight is applied onto the glass rod or a second glass body and collapsed to make an integrated perform glass body.

### BRIEF DESCRIPTION OF THE DRAWINGS

FIG. 1(a) FIG. 1(c) are different types of refractive index profiles of the optical fibers of the present invention.

FIG. 2 is a schematic view explaining the production method of the embodiment 1.

FIG. 3 is graph which shows the transmission loss spectrum of the optical fiber of the embodiment 1.

FIG. 4 is graph which shows the wavelength vs chromatic dispersion characteristic of the optical fiber of the embodiment 1.

FIG. 5(a) is refractive index profile of the optical fiber of the embodiment 3.

FIG. 5(b) is a schematic view explaining the production method of embodiment 3.

### DESCRIPTION OF THE PREFERRED EMBODIMENTS

This invention is explained in detail hereafter First, the single mode optical fiber for WDM transmission according to the present invention is explained. The optical fiber of the present invention consists of at least three layers, in which the first core which is doped with Germanium is located at the center, the second core surrounds said first core, the refractive index of which is lower than said first core, and the cladding surrounds said second core, the refractive index of which is higher than said second core and lower than said first core, wherein said single mode optical fiber is characterized in that a cutoff wavelength is 1400 nm or less, a dispersion is 5 to 13 ps/nm/km at 1500 nin, a zero dispersion wavelength is 1400 nm or less, and a transmission loss is 0.5 dB/km or less in the wavelength from said cutoff wavelength to 1600 nm.

Here, the cutoff wavelength is the wavelength greater than which the ratio between the total power, including launched higher order modes, and the fundamental mode power has decreased to less than 01 dB, and hereafter is the cable cutoff wavelength measured by the method according to ITU-T G 650, unless specified.

The Raman amplification can amplify the signal light having the wavelength of about 100 nm longer than the pump light. Therefore, the wavelength band of the pump light needs to be shorter than the wavelength of the signal light of WDM transmission, and needs to be about the same bandwidth as the signal light of WDM transmission.

Pump light has to be transmitted through the fiber stably in WDM transmission. In order to ensure single mode propagation, it is necessary to make the cutoff wavelength shorter than the pump light. Moreover, in order to prevent noise generation by the non-linear effect, it is necessary to make the chromatic dispersion non-zero in all the wavelength regions of signal light and pump light. When it constitutes a transmission line from an optical fiber that has positive chromatic dispersion, it is necessary to make the zero dispersion wavelengths shorter than the pump light.

If both the cutoff wavelength and zero chromatic dispersion wavelength are shorter than 1400 nm, pumping on the longer side of this wavelength will become possible, and if 1500 nm is chosen as a maximum of the pump light wavelength, signal light transmission can be performed from 1500 nm to 1600 nm.

Since, WDM transmission of wider wavelength band will be attained if the pump light wavelength band is wider, it is desirable that the cutoff wavelength and zero chromatic dispersion wavelength are in the shorter wavelength side. In the present invention, cutoff wavelength is shorter than 1400 nm, preferably between 1200 nm and 1400 nm. Moreover, zero chromatic dispersion wavelength is shorter than 1400 nm.

For the long-distance transmission of not only signal light, but also the pump light, it is required that the transmission loss in the whole wavelength band of the signal light and pump light should be low. Since, when hydroxyl ions are present, absorption may arise near 1380 nm and transmission loss may become large. By taking sufficient dehydration treatment and suppressing the absorption peak, long-distance transmission of the pump light in this band can be obtained.

In the present invention, the transmission loss in the band range of cutoff wavelength to 1600 nm is smaller than 0.5 dB/km, and is 0.35 dB/km or less preferably.

If the zero chromatic dispersion wavelength is shorter than at least 1400 nm and if it has a positive chromatic dispersion in the longer wavelength side, WDM transmission in a wavelength band of 150 nm or more is possible and there is no hindrance of FWM. The disorder of the waveform due to the accumulative chromatic dispersion can not be compensated even though a negative dispersion fiber is used, when a chromatic dispersion becomes large in a case where the transmission speed per wavelength become higher, for example, 40 Gbit/s in this wavelength region. Therefore, restrictions of relay (repeater) distance will come out.

In order to prevent the generation of FWM and to reduce the influence of this accumulative chromatic dispersion, a control of the chromatic dispersion at 1500 nm to a certain permissible range is needed. Especially, it is desirable that the slope of the chromatic dispersion to wavelength is flat. In the present invention, the chromatic dispersion at 1500 nm is in the range of 5 to 13 ps/nm/km, and is 5 to 8 ps/nm/km preferably.

It is difficult to acquire the dispersion characteristic mentioned above by simply changing the material dispersion of an optical fiber. To this end, it is necessary to change the waveguide dispersion by changing the refractive index profile. By appropriately choosing the doping concentration of germanium, desired refractive index profile of the fiber structure is set, so that the refractive index of the first core at the center is set to be high and that of the second core surrounding it is lower than that of the cladding or the refractive index of the third core surrounding the second core is higher than the cladding, and such a setting of the profile allows the chromatic dispersion to be set to a predetermined value.

In this invention, it is desired to use either one of the following refractive index profiles;

a first core at the center having high refractive index, a second core surrounding said first core having low refractive index, and cladding having lower refractive index than that of said first core, but higher than that of said second core (W-shape core profile), or

a third core between the cladding and the second core having higher refractive index than that of said cladding (Wseg core profile), or

a fourth core between the cladding and the third core having lower refractive index than the cladding, (Wseg core profile with a trench profile).

Next, the production method of the single mode optical fiber for WDM transmission concerning the present invention is explained. The production method of the optical fiber concerning the present invention is characterized by controlling the mixing of OH impurities in manufacturing part or whole of a core by the Vapor Phase Axial Deposition (VAD) process, and manufacturing a cladding by the Outside Vapor Deposition (OVD) method or the Rod In Tube (RIT) method.

The transmission loss of the optical fiber is decided fundamentally by the infrared absorption based on the Si—O combination and the Rayleigh Scattering loss which is inversely proportional to the fourth power of the wavelength. Furthermore, the imperfect structural scattering which is not dependent on the wavelength and the impurity absorption which is wavelength dependent contribute to the transmission loss and changes it The transmission loss of the optical fiber has been approaching the characteristic loss of the silica glass through the progress of the manufacturing technology of the fibers in recent years.

As regards to the wavelength dependence loss, it is necessary to reduce the concentration of the hydroxyl ions, since the absorption loss which has a peak in 1380 nm will arise if hydroxyl ions presents. Conventionally, since this band was avoided for the use of transmission, the absorption loss, about several dB/km, was not a practical obstacle In order to acquire a loss of only 0.5 dB/km in this band also, however, a sufficient high purity is required.

For the high purity, the soot process is desirable, because after the deposition of the soot material, is advantageous to carry out high purity processing. The soot process is the manufacturing process which produces the glass preform for optical fibers according to the following steps mentioned here.

First, the Si compound (generally SiCl4) was evaporated, then the flame hydrolysis reaction of this in an oxygen-hydrogen flame is performed to generate glass particle. The glass particles are aggregated. This glass particle aggregate is called porous soot preform. The chemical reaction of the flame hydrolysis reaction is as follows.

SiCl₄+2H₂O.>SiO₂+4HCl.

The porous soot preform obtained by this step is sintered at high temperature, and a transparent glass rod is formed. Since the VAD method and the OVD method uses the above principle step, they are included in the soot process.

In the production of the synthetic silica glass by the VAD method, initially Si compound was evaporated followed by the flame hydrolysis reaction of this in an oxygen-hydrogen flame to generate glass particles. These glass particles are sprayed on a target and the porous soot preform is formed, and high temperature processing makes the porous soot preform transparent.

Although a lot of hydroxyl ions are included since a porous soot preform is formed by the flame hydrolysis process, it is possible to carry out dehydration before a sintering step, typically. Consequently, a glass having very low hydroxyl ion can be obtained. In this dehydration process, a porous soot preform is kept in a chlorine containing atmosphere (atmosphere containing chlorine and/or chlorine compound), at sufficiently high temperatures, and the hydrogen which constitutes the hydroxyl ions is replaced by chlorine.

Doping of germanium to increase the refractive index is performed by evaporating germanium tetrachloride and adding the germanium gas with the material gas during the soot forming step. Doping of fluoride to lower the refractive index is done by the addition of a fluoride compound in the materials gas during the a flame hydrolysis reaction, or in the atmosphere gas at the time of vitrification.

Since the effect of fluoride on the reduction of the hydroxyl ions is the same as that of chlorine, a synergy effect appears when fluoride is added to lower the refractive index at the time of vitrification.

Dehydration under the chlorine contained atmosphere is performed at the temperature of 1250 degrees C. or less so that sintering of soot does not happen. It is desirable to dehydrate at a higher temperature in this range (1150-1200 degrees C.). When exceeding 1250 degrees C., sintering of porous soot preform begins to happen. The sintering of porous soot preform during the dehydrating step is disadvantageous for efficiency of impurities removal and dehydration. In the case of porous soot preform which has been subjected to the sintering in some extent, the desired amount of fluoride addition cannot be obtained in the subsequent sintering step. Sintering step is performed in the range of 1200-1500 degrees C., preferably at the temperature of 1300-1400 degrees C., in a fluorine contained atmosphere

In manufacturing the optical fiber, there are methods of manufacturing the preforms for optical fibers with target profiles. The VAD process wherein many burners for a reaction are arranged in the same plane perpendicularly is used to manufacture the glass rod as a core, or the method of producing a part of the core by the VAD process with a few burners and further producing additional required layers by the OVD process is used.

When manufacturing the optical fiber which has first to fourth cores and cladding, while the first to fourth core soot can be deposited in a single step using many burners, it is also possible to initially deposit the first and the second core soot and then subsequently deposit the third and the fourth core soot.

In the case of production of the core portion, although germanium is not added into the portion which serves as a low refractive index part and added only into the portion used as a high refractive index part, depending on the selected refractive index profile parameter, very-small-quantity doping may be carried out and germanium may be adjusted to the portion used as a low refractive index part The quantity of germanium doped into each portion is suitably determined so that the target (required) refractive index is obtained.

Although cladding part can be simultaneously formed with a core part by the VAD method, to maintain the size accuracy of an optical fiber, it is desirable to produce the cladding by different steps. In the OVD process, soot for the cladding part is deposited onto the glass rod used for the core part. In the Rod in Tube process, the cladding part is made by inserting the core part glass rod into a silica tube and collapsing them.

In order to reduce hydroxyl ions content, when using the soot process, dehydration of the porous soot preform was carried out at temperatures below 1250 degrees C. under the chlorine contained atmosphere. When using the Rod in Tube method, the glass rod used as a core is elongated after softening it by heating, and then etching or polishing of the surface is carried out by which the water (hydrous) layer is removed, and silica glass tubes having hydroxyl ion content of 100 ppm or less are used. Although based on the drawing conditions, etc., ideally it is desirable that a silica glass tube having hydroxyl ions content of 1 ppm or less is used.

In the case of the preform formed by two or more steps, the pollution removal and smoothening of the surface of a glass rod, which serve as a core, are important. However, there is a risk of moisture mixing in an interface by heating the glass rod to remove the impurities on the glass surface or by heating and elongating the glass rod to reduce the size of glass rod diameter so that the thickness of cladding layer applied thereon may be thin.

If this water (hydrous) layer is removed, a stable low hydroxyl ion content can be attained. Moreover, in order to prevent generation of air bubbles at the surface, etc., it is necessary to make it flat and smooth. As the removal methods of a water layer, there are methods such as wet etching in which the glass rod is immersed into a liquid to dissolve the surface portion, polishing in which the surface layer is mechanically polished, sublimating in which the surface layer is sublimated by laser or the plasma flame, etc., and they all have equivalent effects.

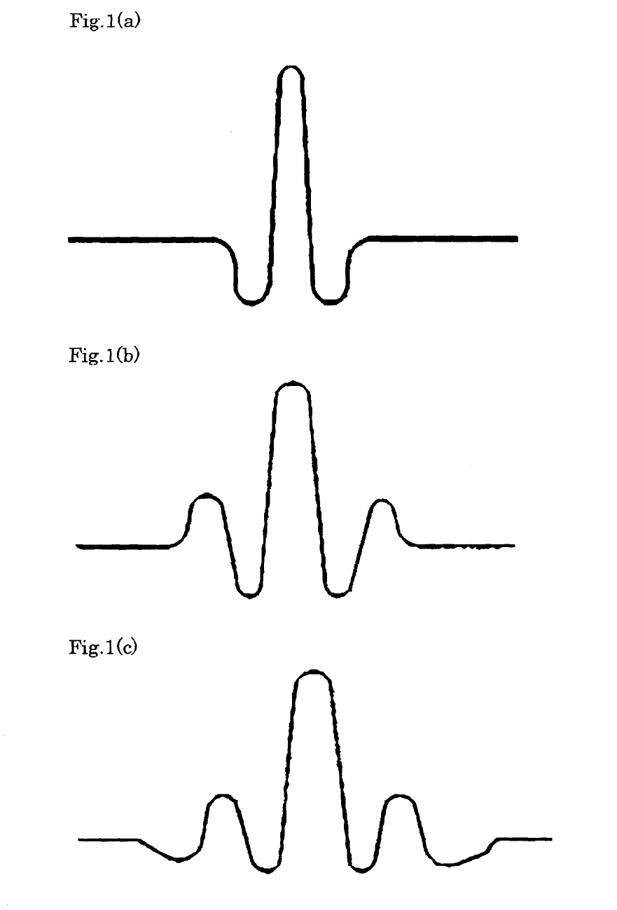

Hereafter, although this invention is explained in detail based on embodiments, still this invention is not limited to only those embodiments. The refractive index profiles of the single mode optical fibers manufactured with the embodiments are shown in the FIG. 1. FIG. 1(a)-FIG. 1(c) are figures, each showing the refractive-index profile of the optical fiber of this invention, respectively. FIG. 1(a) and FIG. 1(b) are the so called W shape profile and Wseg profile, respectively. FIG. 1(c) is a so called Wseg profile with a trench. In each figure, the position of the radius direction of an optical fiber is shown horizontally, and a refractive index is shown vertically.

[Embodiment 1]

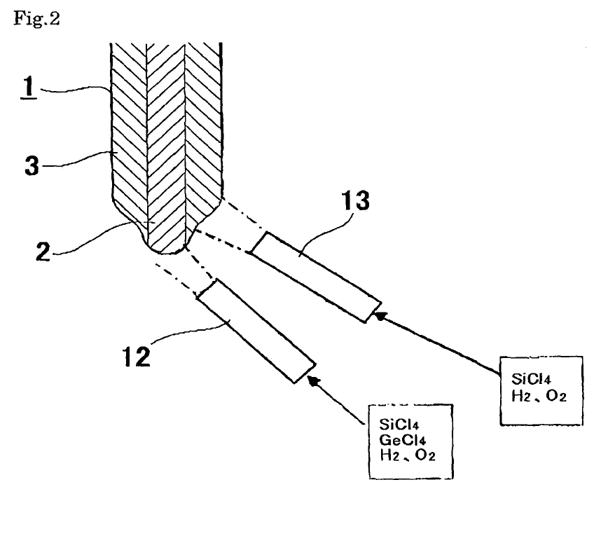

The preform for optical fibers with the refractive index profile shown in FIG. 1(a) was produced. First, the core having two layers was deposited using the VAD equipment provided with two burners. The schematical view explaining the manufacturing method of embodiment 1 is shown in FIG. 2. The first core 2 was formed with the burner 12, the second core 3 was formed with the burner 13, and thus the porous soot preform 1 was produced. Germanium was doped to the first core at the rate of 10 g/min of the mass flux of GeCl₄ gas and the second core was not doped with germanium Subsequently, the resultant porous soot preform was made into transparent glass under the atmosphere containing fluoride. Dehydration and vitrification conditions are as in Table 1.

TABLE 1

| | first Step | second Step |
|---|---|---|
| Fireplace Temperature | 1200° C. | 1350° C. |
| He Gas | 10 l/min | 10 l/min |
| Fluorine compound Gas | — | 3.0 l/min |
| Chlorine Gas | 0.5 l/min | 0.5 l/min |

This perform was heated and elongated by the oxygen-hydrogen flame, and the removal of the hydroxyl ions diffused into the surface during elongation was carried out by etching the surface using HF solution. This core rod is divided into two pieces. Cladding was formed on one core rod piece by soot method and on the other core rod piece by Rod in Tube method, respectively. The porous soot of the cladding is vitrified under an atmosphere containing chlorine. This dehydration and vitrification conditions are shown in Table 2.

TABLE 2

| | first Step | second Step |
|---|---|---|
| Fireplace Temperature | 1200° C. | 1550° C. |
| He Gas | 10 1/min | 10 l/min |
| Chlorine Gas | 0.5 l/min | 0.5 l/min |

In the case of the Rod in Tube method, after the removal of the hydroxyl ions from the surface of the core rod, the core rod is inserted in to a silica tube having the hydroxyl ion content of 100 ppm, heated and collapsed. Drawing these preforms, the single mode optical fibers with the transmission characteristics shown in Table 3 were obtained.

TABLE 3

| | | | | | Dispersion | Zero |
|---|---|---|---|---|---|---|
| Transmission loss | | MFD | Cut off | Dispersion | slope | dispersion |
| (db/km) | | (μm) | wavelength | (ps/km/nm) | (ps/km/nm²) | wavelength |
| @ 1310 nm | @ 1550 nm | @ 1550 nm | (nm) | @ 1500 nm | @ 1500 nm | (nm) |
| 0.361 | 0.197 | 7.8 | 1365 | 7.0 | 0.05 | 1370 |

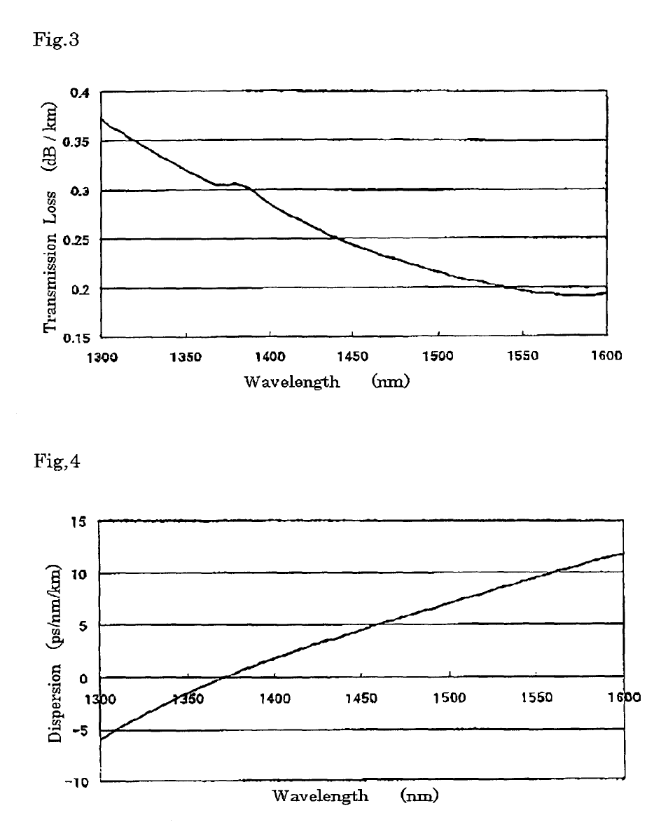

The outer diameter of the resultant optical fiber was 125 μm, the outer diameter of the first core is 3.2 μm, the thickness of the second core is 3.0 μm and that of the cladding is 57.9 μm. The loss spectrum and the wavelength characteristics of the chromatic dispersion of the optical fibers produced by the soot method are shown in FIG. 3 and FIG. 4, respectively. The optical fibers produced by rod in tube method are also confirmed to have similar loss spectrum and wavelength characteristics of the chromatic dispersion. With using these fibers, the Raman amplification line for an pumping light source of a wavelength of 1400 nm was constituted The high-speed transmission test on this Line was conducted in 40 G bit/s and good transmission characteristics were obtained.

[Embodiment 2]

Next, the preform for optical fibers with the refractive-index profile shown in FIG. 1(b) was produced. The following two manufacturing processes (1) and (2) were adopted for making the core of three-layer structure.

(1) Single step process:

This process uses the VAD equipment provided with three burners. Germanium was doped to the first core, located at the center, at the rate of 85 g/min of the mass flux of GeCl₄ gas, the second core was not doped with germanium and the third core waS doped with germanium at the rate of 6.5 g/min of the mass flux of GeCl_{fourth} is was made into a transparent glass under an atmosphere containing fluoride. Dehydration and vitrification conditions are the same as in embodiment 1 (refer to Table 1). This preform was heated and elongated by the oxygen-hydrogen flame, and etching of the surface was carried out using HF solution. With the Rod In Tube method, the cladding is formed onto this core rod. These conditions are the same as indicated in the embodiment 1. Drawing these preforms, the single mode optical fibers with the transmission characteristics shown in Table 4 were obtained

TABLE 4

| | | | | | Dispersion | Zero |
|---|---|---|---|---|---|---|
| Transmission loss | | MFD | Cut off | Dispersion | slope | dispersion |
| (dB/km) | | (μm) | wavelength | (ps/km/nm) | (ps/km/nm²) | wavelength |
| @ 1310 nm | @ 1550 nm | @ 1550 nm | (nm) | @ 1500 nm | @ 1500 nm | (nm) |
| 0.354 | 0.193 | 8.2 | 1290 | 5.5 | 0.04 | 1374 |

The outer diameter of the resultant optical fiber was 125 μm, the diameter of the first core was 2.8 μm and the thickness of second core, third core and the cladding were 2.5 μm, 2.2 μm and 56.4 μm, respectively. As a result of the high speed transmission test shown in embodiment 1 for the Raman amplification line using these fibers, high-speed transmission of 40 Gbit/s was possible.

(2) Two step process:

The VAD equipment provided with two burners like in embodiment 1 is used for this method. The portions equivalent to the first core and the second core were produced in the same manner as in embodiment 1. Next, after heating and elongating this glass preform and carrying out etching or polishing of the surface, the porous soot preform which was doped with germanium at the rate of 4.5 g/min of the mass flux of GeCl₄ gas was deposited on it, and this was made into transparent glass on the conditions shown in Table 1 of the embodiment 1.

After heating and elongating this glass preform further and carrying out etching or polishing of the surface, a porous soot not doped with germanium was deposited on it, and the resulted structure was made into transparent glass on the conditions shown in Table 2 of the embodiment 1. Drawing these preforms, the single mode optical fibers with the transmission characteristics shown in Table 5 were obtained.

TABLE 5

| | | | | | Dispersion | Zero |
|---|---|---|---|---|---|---|
| Transmission loss | | MFD | Cut off | Dispersion | slope | dispersion |
| (dB/km) | | (μm) | wavelength | (ps/km/nm) | (ps/km/nm²) | wavelength |
| @ 1310 nm | @ 1550 nm | @ 1550 nm | (nm) | @ 1500 nm | @ 1500 nm | (nm) |
| 0.389 | 0.212 | 9.4 | 1370 | 10.3 | 0.09 | 1388 |

The outer diameter of the resultant optical fiber was 125 μm, the diameter of the first core was 3.2 μm and the thickness of second core, third core and the cladding were 2.9 μm, 2.5 μm and 55.5 μm, respectively. As a result of the high speed transmission test shown in embodiment 1 for the Raman amplification line using these fibers, high-speed transmission of 40 Gbit/s was possible.

[Embodiment 3]

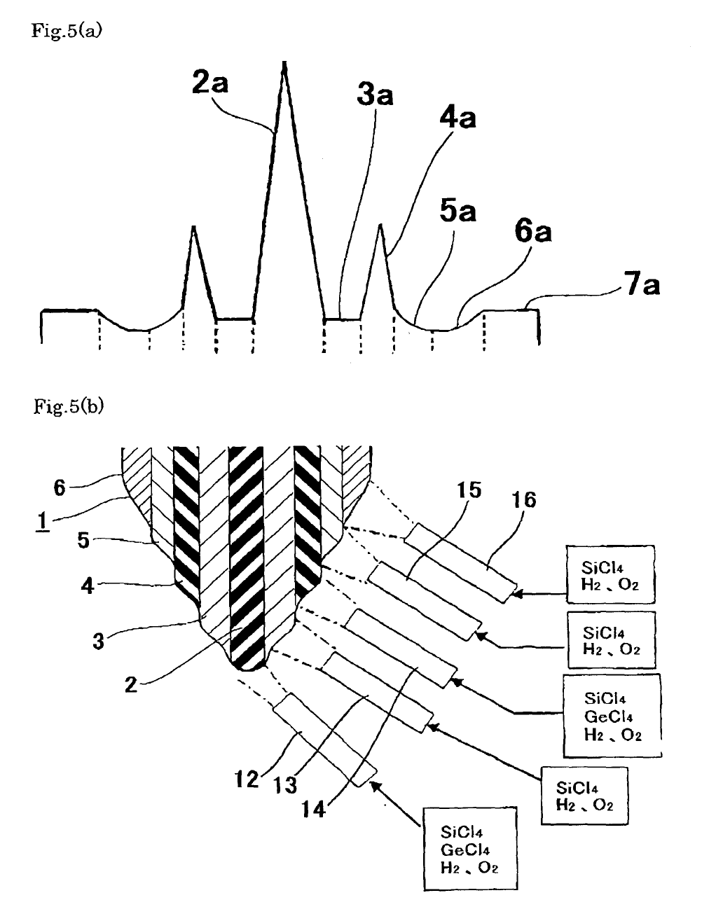

Next, the preform for optical fibers with the refractive-index profile shown in FIG. 1(c) was produced. The porous soot having four layers was deposited using the VAD equipment provided with five burners. The manufacturing method of this embodiment is explained with reference to FIG. 5. FIG. 5(a) shows the refractive index profile of this embodiment. The optical fiber concerning this embodiment has the first core 2a at the center, the second core 3a having a refractive index lower than the first core 2a surrounding the first core 2a, the third core 4a having a refractive index higher than the refractive index of cladding 7a surrounding the second core 3a, the fourth core 5a and 6a having a refractive index lower than cladding 7a surrounding the third core 4a, and the cladding 7a surrounding it, as shown in FIG. 5(a).

FIG. 5(b) is a schematic view explaining the manufacturing method of this embodiment. The first core 2 was formed with the burner 12, the second core 3 was formed with the burner 13, the third core 4 was formed with the burner 1 fourthe inner side of the fourth core 6 was formed with the burner 15, the outer side of the fourth core 6 was formed with the burner 16 so that the porous soot preform 1 was produced. Germanium was doped to the first and third core at the rate of 9.5 g/min and 7.0 g/min of the mass flux of GeCl₄ gas and the second and fourth core were not doped with germanium The resultant porous perform 1 was made into transparent glass through sintering under the atmosphere containing fluoride. Dehydration and vitrification conditions are the same as that in embodiment 1 (refer to Table 1).

This perform was heated and elongated by the oxygen-hydrogen flame, and etching of the surface was carried out using HF solution. By using the Rod In Tube method, the cladding is formed onto this core rod. These conditions are the same as the contents indicated in the embodiment 1. While the cladding was produced by the soot method, it was satisfactory. Drawing these preforms, the single mode optical fibers with the transmission characteristics shown in Table 6 were obtained.

TABLE 6

| | | | | | Dispersion | Zero |
|---|---|---|---|---|---|---|
| Transmission loss | | MFD | Cut off | Dispersion | slope | dispersion |
| (dB/km) | | (μm) | wavelength | (ps/km/nm) | (ps/km/nm²) | wavelength |
| @ 1310 nm | @ 1550 nm | @ 1550 nm | (nm) | @ 1500 nm | @ 1500 nm | (nm) |
| 0.347 | 0.189 | 8.6 | 1345 | 9.5 | 0.065 | 1364 |

The outer diameter of the resultant optical fiber was 125 μm, the diameter of the first core was 28 μm and the thickness of second core, third core, fourth core and the cladding were 2.5 μm, 2.3 μm, 3.6 μm and 52.7 μm, respectively. As a result of the high speed transmission test shown in embodiment 1 for the Raman amplification line using these fibers, high-speed transmission of 40 Gbit/s was possible.

According to the manufacturing method of the optical fiber of the present invention, an optical fiber with a low transmission loss and small chromatic dispersion can be offered. By using the optical fibers of the present invention, we can perform high speed WDM transmission using pump light of 1400 nm-1500 nm, which was not conventionally used for WDM, and the Raman amplification of 1500 nm-1600 nm wherein the generation of the noise due to non-linear effect is suppressed.

What is claimed is:

1. A single mode optical fiber for wavelength division multiplexing (WDM) transmission comprising
a first core doped with at least Germanium,
a second core surrounding said first core, the refractive index of which is lower than said first core, and
a cladding surrounding said second core, the refractive index of which is higher than said second core and lower than said first core,
wherein a cutoff wavelength is 1400 nm or shorter, a dispersion is in a range of 5 to 13 ps/nm/km at 1500 nm, a zero dispersion wavelength is 1400 nm or shorter, and a transmission loss is 0.5 dB/km or less in a wavelength range of said cutoff wavelength to 1600 nm.

2. The single mode optical fiber according to claim 1 further comprising a third core between said second core and said cladding, the refractive index of which is higher than said cladding.

3. The single mode optical fiber according to claim 2 further comprising a fourth core between said third core and said cladding and the refractive index of which is lower than said cladding.

4. A method for producing a preform of the single mode optical fiber of claim 1 comprising the steps:
forming a porous soot preform of silica by flame hydrolysis process with adjusting a doping concentration of Germanium according to a required refractive index profile, dehydrating said porous soot preform in an atmosphere containing at least one selected from a group of chlorine and chlorine composites at a temperature of 1250° C. or less, and sintering the dehydrated porous soot preform in an atmosphere containing fluorine to make a first transparent glass rod of the preform.

5. A method according to claim 4 further comprising the steps:
forming a porous soot layer around the first transparent glass rod by flame hydrolysis process, dehydrating said porous soot layer in the chlorine atmosphere at a temperature of 1250° C., or loss, and sintering said porous soot layer in the fluorine atmosphere to transform the porous soot layer into a first transparent glass layer of additional core layer on the first glass rod.

6. A method according to claim 4 further comprising the steps of:
forming a porous soot layer of silica surrounding the first transparent glass rod by flame hydrolysis process, dehydrating said porous soot layer in the chlorine containing atmosphere at a temperature of 1250° C. or less, sintering said porous soot layer to transform said soot layer into a first transparent glass layer of cladding on the first glass rod.

7. A method according to claim 5 further comprising the steps of:
forming of a porous soot layer of silica surrounding a second glass rod which comprises the first transparent glass rod and the transparent glass layer of additional core layer by flame hydrolysis process,
dehydrating said porous soot layer in the chlorine containing atmosphere at a temperature of 1250° C. or less,
sintering said porous soot layer to transform the porous soot layer into a first transparent glass layer of cladding on the second glass rod.

8. A method according to claim 5, wherein before the formation of said porous soot layer, said first transparent first glass rod is elongated after softening it by heating, and a hydrous layer in the first transparent glass rod is removed by etching or polishing the surface.

9. A method according to claim 6, wherein before the formation of said porous soot layer, said first transparent glass rod is elongated after softening it by heating, and a hydrous layer in the first transparent glass rod is removed by etching and polishing the surface.

10. A method according to claim 7, wherein before the formation of said porous soot layer, said second transparent glass rod is elongated after softening it by heating, and a hydrous layer in the transparent glass body is removed by etching and polishing the surface.

11. A method according to claim 4 further comprising the steps of:
elongating said first transparent glass rod after softening it by heating, and removing a hydrous layer in the first transparent glass rod by etching and polishing the surface, providing a silica tube having a concentration of hydroxyl less than 100 parts per million by weight for cladding, inserting said first transparent glass rod into said silica tube, and
collapsing said silica tube by heating.

12. A method according to claim 5 further comprising the steps of:
elongating a second glass rod which comprises the first transparent glass rod and the transparent glass layer of additional core layer after softening it by heating, and removing a hydrous layer in the second transparent glass rod by etching and polishing the surface,
providing a silica tube having a concentration of hydroxyl ions less than 100 parts per million by weight for cladding, inserting said second transparent glass rod into said silica tube, and
collapsing said silica tube by heating.

13. A method according to claim 6 further comprising the steps of:
etching or polishing a hydrous layer on the surface of the cladding;
providing a silica tube having a concentration of hydroxyl ions less than 100 parts per million weight for an additional cladding;
inserting said first glass rod and cladding into said silica tube; and
collapsing said silica tube by heating.

14. A method according to claim 7 further comprising the steps of:
etching or polishing a hydrous layer on the surface of the cladding;
providing a silica tube having a concentration of hydroxyl ions less than 100 parts per million weight for an additional cladding;
inserting said first and second glass rods and cladding into said silica tube; and
collapsing said silica tube by heating.
